(19) United States
(12) Patent Application Publication
(10) Pub. No.: US 2013/0066482 A1
(43) Pub. Date: Mar. 14, 2013

(54) APPARATUS AND METHOD FOR EXECUTING ENERGY DEMAND RESPONSE PROCESS IN AN ELECTRICAL POWER NETWORK

(71) Applicants: Ying Li, Garland, TX (US); Mark Trayer, Allen, TX (US); Boon Loong Ng, Richardson, TX (US); Nhut Nguyen, Richardson, TX (US); Kong Posh Bhat, Plano, TX (US)

(72) Inventors: Ying Li, Garland, TX (US); Mark Trayer, Allen, TX (US); Boon Loong Ng, Richardson, TX (US); Nhut Nguyen, Richardson, TX (US); Kong Posh Bhat, Plano, TX (US)

(73) Assignee: Samsung Electronics Co., Ltd., Suwon-si (KR)

(21) Appl. No.: 13/610,333

(22) Filed: Sep. 11, 2012

Related U.S. Application Data
(60) Provisional application No. 61/534,317, filed on Sep. 13, 2011.

(51) Int. Cl. G05B 11/01

(52) U.S. Cl. 700/297

(57) ABSTRACT

A demand response (DR) architecture performs processes for use in an electrical power network. The DR architecture performs a method for selecting a process to use for scheduling devices. The method includes receiving, by a demand response controller, demand response specific input. The method includes determining a process to use to schedule device running time patterns, based on the received input. The method further includes executing the determined process.

### CROSS-REFERENCE TO RELATED APPLICATION(S) AND CLAIM OF PRIORITY

The present application claims priority to U.S. Provisional Patent Application Ser. No. 61/534,317 filed Sep. 13, 2011, entitled “DEMAND RESPONSE ARCHITECTURE AND ALGORITHMS.” The content of the above-identified patent documents is incorporated herein by reference.

### TECHNICAL FIELD

The present application relates generally to energy usage algorithms and, more specifically, to an apparatus and method for executing energy demand response algorithms in an electrical power network.

### BACKGROUND

While the demand for electricity is increasing worldwide, meeting the demand has become more expensive. One way to meet energy demands involves finding alternative energy sources, which has been an important focus for decades. Additionally, efforts to reduce electricity consumption ranging from switching to a new type of light bulb, designing buildings that have better insulation, to building more efficient appliances have also become common ways to decrease electricity usage.

Because the demand for electricity varies throughout the day, some electrical utility companies (UCs) change the price of electricity accordingly. As one might expect, when there is less demand, the price charged for electricity is less than when the demand is higher. This is sometimes referred to as “demand” or “peak” pricing. So far, being able to take advantage of lower electricity prices during off-peak times has largely been based on educated guesses using devices, such as simple timers, which have not been optimized to work in such an environment. Previous attempts at scheduling operations have been heuristic in nature, without clear definitions of the objective metric sought to be optimized over. While heuristic solutions may be adequate in some situations, their performance cannot be guaranteed in all situations of interest.

### SUMMARY

A demand response (DR) architecture for use in an electrical power network is provided. The DR architecture comprises a plurality of smart meters, sensors, and appliances. The DR architecture comprises a DR controller and a processor associated with the DR controller. The processor is configured to receive DR specific input. The processor is configured to determine a process to use to schedule device running time patterns based on the received input. The processor is further configured to execute the determined process.

A method for selecting a process to use for scheduling devices is provided. The method comprises receiving, by a demand response controller, demand response specific input. The method includes determining a process to use to schedule device running time patterns, based on the received input. The method further includes executing the determined process.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device can be implemented in hardware, firmware or software, or some combination of at least two of the same. It should be noted that the functionality associated with any particular controller can be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a demand response (DR) architecture according to embodiments of the present disclosure;

FIG. 2 illustrates the DR architecture according to embodiments of the present disclosure;

FIG. 3 illustrates a price based appliance scheduling process according to embodiments of the present disclosure;

FIG. 4 illustrates a direct scheduling process according to embodiments of the present disclosure;

FIG. 5 illustrates a spike control process with max power signaling according to embodiments of the present disclosure;

FIG. 6 illustrates a flow diagram of various demand response scheduling processes according to embodiments of the present disclosure;

FIG. 7 illustrates a user interface for a device according to embodiments of the present disclosure;

FIG. 8 illustrates user interfaces including tradeoff parameter settings for multiple devices according to embodiments of the present disclosure; and

FIG. 9 illustrates a process for demand response device timing according to embodiments of the present disclosure.

### DETAILED DESCRIPTION

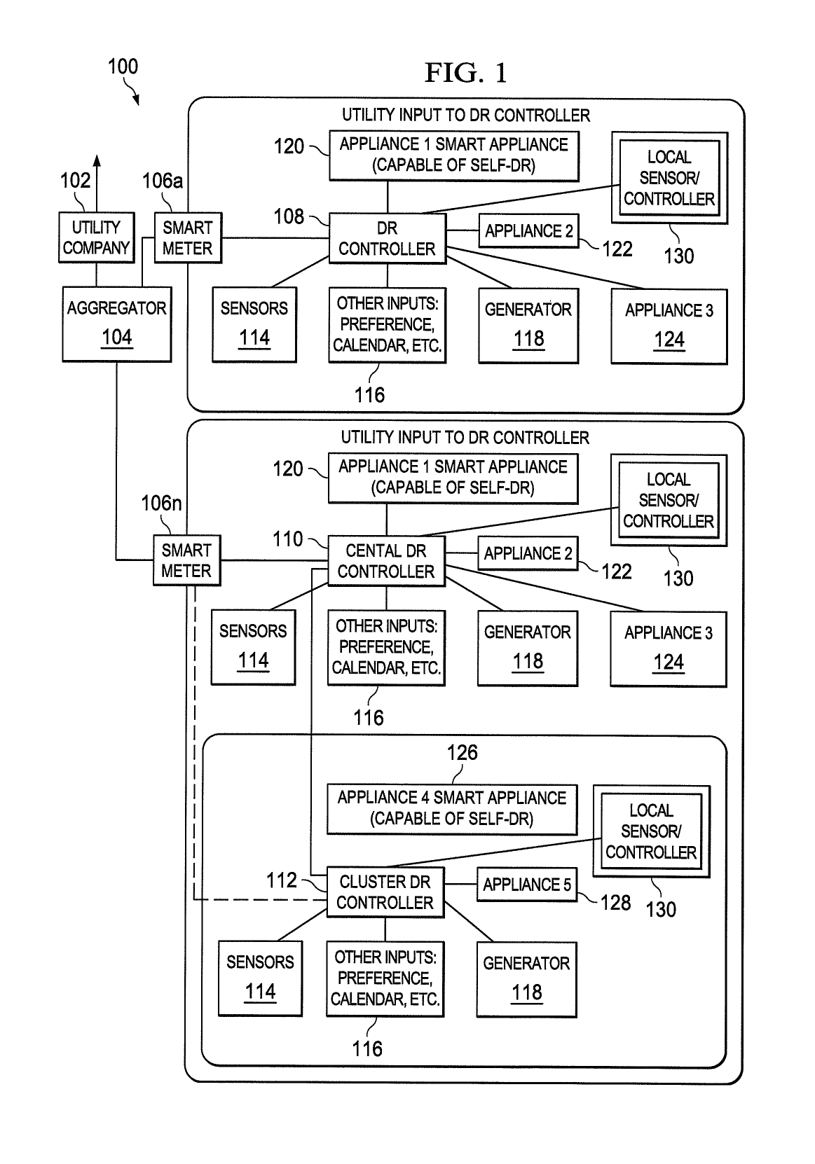

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure can be implemented in any suitably arranged device.

FIG. 1 illustrates a demand response (DR) architecture 100 according to embodiments of the present disclosure. The embodiment of the DR architecture 100 shown in FIG. 1 is for illustration only. Other embodiments could be used without departing from the scope of this disclosure.

Power sources, such as utility companies 102 or aggregators 104, provide electricity to power sinks that consume electrical power, such as homes and businesses. Power sinks record their energy consumption using devices referred to as smart meters 106a-106n, (collectively 106).

An individual premise (or home), consisting of a set of devices consuming electrical power, and drawing the power through an interface to an external power supply utility, can be referred to as a home area. The devices can be interconnected to form a Home Area Network (HAN). It should be noted that the term “Home” is used in a generic sense—such a description also applies to other structures, such as a typical office building, single office/home office (SOHO), small enterprise, medium enterprise, and large enterprise developments, for example.

A desirable feature of an electrical utility network, such as the HAN, is the ability of a consumer to respond to various events taking place in the network. Such an event can be a change in the electricity prices published by their utility company (UC). The consumer's response can include adjusting power consumption within the HAN by load shedding, load shaping or load shifting. These operations require efficient demand-response processes.

Although a consumer could manually implement some demand-response strategies, the importance of an automated architecture that monitors and dynamically adjusts to quickly changing real time information is paramount. A Demand-Response (DR) controller 108 is a critical component of such an architecture. One of the DR controller's 108 main functionalities is dynamically scheduling the operation of power consuming appliances upon receiving real-time information (e.g., pricing) from the network.

Communication with different devices within the HAN is based on short range wireless technologies such as Zigbee, Wi-Fi, cellular, and the like. DR controllers are becoming more common in big commercial buildings and are subject to active research.

In certain embodiments, the DR controller 108 collects inputs from smart meters 106, sensors 114, appliances 120, 122, 124, 126, 128, energy local generator storage 118, status and other inputs from an analytics engine 116, or similar entity, such as preferences, calendar information, and the like, and runs processes to schedule the devices running time patterns.

The smart meter 106, as one possible interface between the utility and the customer, obtains information related to the smart grid (e.g., real-time price, day ahead predicted price, load, maximum allowable load, price with respect to the load, etc.) from the utility. In certain example, this information is equally available via other means such as direct packet-based communications to the DR controller from the Utility 102 or Aggregator 104.

In certain embodiments, the DR controller 108 further processes information from the smart meter 106 or the grid, based on its needs.

The sensors 114 are one or more of: sensors configured to sense temperature; motion detectors configured to sense whether there is someone entering the room or leaving the room; or any other type of suitable sensor.

The appliances 120-128 include some smart appliances 120, 126 that have the capability of self-scheduling based on information received from the smart meter or “the grid.” The appliances 120-128 also include normal appliances 122, 124, 128, that require human intervention to manually turn on and off, or which have switches controlled by the DR controller 108 according to the scheduling solution derived by a DR process.

The energy local generator and storage 118 can interactively exchange information with the DR controller 108 and react accordingly. For example, when the electricity is at low price, the storage 118 can store energy, while the electricity is at high price, the generator and storage 118 can sell electricity back to the grid.

In certain embodiments, the preferences 116 are one or more of: deadline requirements, priorities, tradeoff between the comfortable level and money savings, and the like. The input 116 from an analytics engine is the result of analysis on both local environment meta-data, such as humidity or temperature readings, as well as contextual meta-data such as historical calendaring information. In certain embodiments, such information is combined with other information to enable the DR controller 108 to infer whether a room is automatically pre-cooling or raising temperature depending upon the room usage calendar, for example. In another example, the DR controller 108 automatically shuts down or places certain devices in stand-by if the DR controller 108 knows that, for a certain period of time, there would be no one using the facility based on the calendar.

In certain embodiments, communications between elements such as smart meters 106, DR controller 108, appliances 120-128, etc., are wireline or wireless. Wireless technologies include Zigbee, Wi-Fi, cellular, and the like. Wireline technologies include phone lines, Ethernet, power line communications, and the like.

In certain embodiments, the DR architecture 100 includes multiple levels of DR controllers 108. A central DR controller 110 includes cluster DR controllers 112 under its domain. The central DR controller 110 coordinates with one or more cluster DR controllers 112. In certain embodiments, the cluster controller 112 obtains processed grid information from the central controller 110, or the information from the smart meter 106 itself. In certain embodiments, parallel DR controllers connect to the smart meter 106 directly.

In certain embodiments, the DR controller 108 is connected to local sensors or controllers. In certain embodiments, local controllers 130 are connected directly to the smart meter to obtain grid related information such as electricity prices, and the like. Other information, such as preferences, calendars, and so forth, can be used as the input 116 of the local controllers 108, 110, 112.

In certain embodiments, the DR architecture 100 incorporates a hierarchy of DR controllers 108. For example, in Multi-dwelling units, such as condos and apartments, such a hierarchal based DR architecture 100 includes individual DR controllers, such as cluster DR controller 112, controlling each apartment on a floor independently of the other DR controllers on that floor, with each of the DR controllers 112 being provided power caps and pricing inputs by a floor DR controller connected to the apartment DR controllers on the floor, such as a central DR controller 110, with the floor DR controllers 110 themselves being connected to and being provided inputs by a building DR controller, which can be another central DR controller 110.

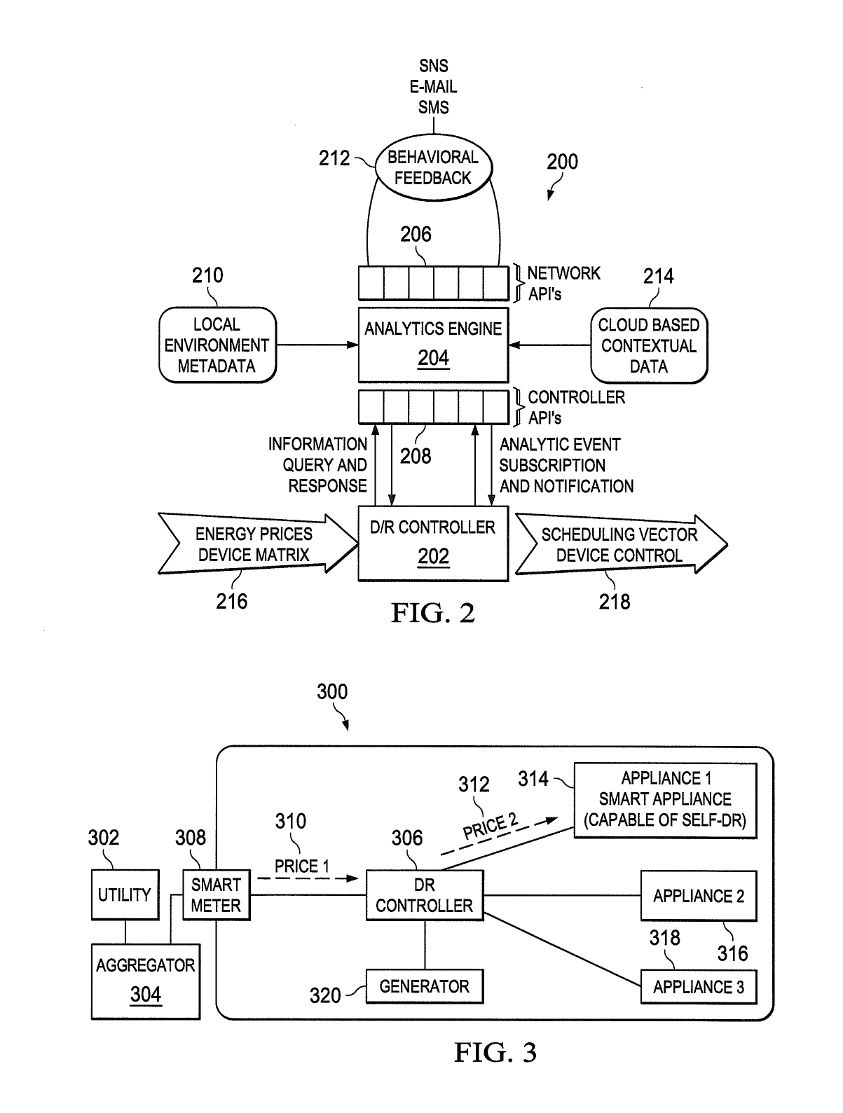

FIG. 2 illustrate a DR architecture 200 according to embodiments of the present disclosure. The embodiment of the DR architecture 200 shown in FIG. 2 is for illustration only. Other embodiments could be used without departing from the scope of this disclosure.

In certain embodiments, local environment metadata 210 is used as input and/or output to the DR controller 202, where the local environment metadata 210 includes, for each room or space, a value for the humidity, temperature, occupancy, window status, door status, blind/shutter status, sensor data, and other similar metadata. Alternatively, the environment metadata 210 is used as input for an analytics engine 204, which can have communications and information exchanges with the DR controller 202.

In certain embodiments, the analytics engine 204 are part of the entire DR controller 202 rather than a separate component.

In certain embodiments, behavioral feedback is provided from the use of e-mails, short messages, scheduler, calendars, and so forth, and can be part of the input and/or output of the analytics engine 204. The behavioral feedback 212 may be received by interfacing with the analytics engine 204 via network APIs 206.

Controller APIs 208 can be used for the interface between the analytics engine 204 and the DR controller 202.

In certain embodiments, cloud based contextual data 214, such as energy trading data, historical use data, disambiguated personal data, weather information, and the like, is used as input and/or output of the analytics engine.

Information query and response, as well as analytic event subscription and notifications, and the like, is communicated via controller APIs 208 for communications between the D/R controller 202 and analytics engine 204.

In certain embodiments, energy prices, device metrics such as device power, required running time, preferred running time, and the like, are used as input 216 to the DR controller 202. The DR controller 202 outputs the scheduling vector and device control information 218, to schedule devices to run, according to the data analyzed by the analytics engine and the DR process.

In certain embodiments, some examples of the DR process with energy analytics engine are as follows. In one example, if the weather information informs the engine or the DR controller 202 that there will be sufficient rain in the following twenty-four hours, then DR controlling system 200 may not schedule the sprinklers to run. If the sensors of the lawn inform the analytics engine or the DR controller 202 that the sprinklers need to run (e.g., due to the inaccurate weather forecast: after twenty-four hours the rain does not come), the DR controlling system 200 can select a time considering the price and other information to run the sprinklers. In another example, the calendar information of a conference room can be communicated to the analytics engine, or the DR controller 202. Then, if there will be no one using the room, the conference room temperature in the summer can be set higher automatically by the DR controlling system 200, to save energy. In addition, prior to the conference room's scheduled activity, the DR controlling system 200 can pre-cool the room. In another example, the calendar information of the employees can be communicated to the analytics engine or the DR controller 202, so that if all the employees are out for a meeting, then the DR controlling system 200 can set the temperature of office area to high amount automatically, and prior to a return of the employees to the office area, the DR controlling system 200 can pre-cool the area. In another example, the end-user or end-consumer can set the required or preferred deadline of a load to be done (e.g., the load of washing machine, pool pump, dish washer, etc.), set the preferred tradeoff parameters on end-consumer's happiness about the service provided by appliance (such as the cooled temperature, high definition TV, the earlier time that a load is done, etc.) and the money or the bill that the end-consumer has to pay to get the happiness. The information from the end-consumer can be input via the human-machine interface, through which the end-consumer can input the preferences, tradeoff parameters, query information, etc., and after a prediction calculated by the DR controlling system 200, the interface can also feed back to the end-consumer a predicted money consumption. If the end-consumer adjusts the query, or the preferences, parameters, and the like, the predicted money consumption can also be changed. The end-consumer can then choose a set of parameters, preferences, taking into account the feedback from the queries.

In certain embodiments, the DR controller 202 is customizable for different possibilities or scenarios of DR programs that utility companies offer or in which the customer enrolls. The DR programs include, in various disclosed embodiments one or more of: a time-of-use DR program, which typically has two flat prices, one for day and one for night; real-time-price DR program, which offers real time price data to the customer; and incentive based DR program, which may give a rebate or incentive to the customer if the customer shifts or reduces their load at certain times. Other variations for DR programs are considered within the scope of this disclosure. Depending upon the utility policies or the DR program(s) in which the customer enrolls, the chosen DR process is resilient to support the variations.

FIG. 3 illustrates a price based appliance scheduling process 300 according to embodiments of the present disclosure. The embodiment of the price based appliance scheduling process 300 shown in FIG. 3 is for illustration only. Other embodiments could be used without departing from the scope of this disclosure.

In certain embodiments, a utility company 302 or aggregator 304 provides price information 310 to a consumer via a smart meter 308. The consumer runs a DR process using the DR controller 306 to schedule appliances reasonably based on the received price information 310. The price information 310 can include the real-time price, the day-ahead price, predicted price, or any other price not specifically described. The DR controller 306 processes the price 310 received from the smart meter 308, and sends the processed price 312 to other devices such as smart appliance 314 or normal appliances 316, 318.

In certain embodiments, the DR controller 306 predicts an expected price based on price history stored in the DR controller 306, the price such as instantaneous price, day ahead price, or any other price information that it receives from the smart meter. The DR controller 306 then sends the predicted price to other devices such as the smart appliances 314 and the normal appliances 316, 318. A generator 320 also receives the pricing information from the DR controller 306. As described previously, the generator 320 can choose to sell electrical power to the grid based on the received price 312 being high, in order to take advantage of the high price.

If every customer schedules their schedulable appliances in the window having the lowest price, or, if DR processes are similar and opportunistically schedule as many as possible appliances to run over time intervals with the lowest price, these time intervals may encounter spikes in electricity use, resulting in some rebound peaks.

These spikes are very different from the peaks that ordinarily occur during the day time, where most likely the peaks are from the commercial buildings or businesses, where their appliances have to be used for their business. Business customers do not often have the luxury to be able to reschedule their electrical usage. A usage peak occurring during the day time typically is not due to a low price, which attracts a lot of appliances scheduled to take advantage of low price. However, spikes in low price time intervals can occur when multiple users schedule as many possible appliances as possible to take advantage of the low price time intervals. In certain embodiments, flexible scheduling for those appliances can remedy or lessen the effects of low price time spikes if the devices are scheduled with flexibility. In other words, rebound peaks caused by scheduling may be unnecessary, because there is generally more flexibility with these appliances—not like the peak at the daytime when many appliances have to be scheduled for business purposes.

There are a number of embodiments described below to prevent such spikes. One embodiment describes having a period of time with a flat price, and randomizing the scheduling so that all of the appliances do not commence operation at a single time. In certain embodiments, the utility company provides a flat price for time intervals which may be suitable for appliances with flexible schedules. The DR process can be configured to use randomization, if some flat price is given, to shift the scheduling randomly within the time intervals with the same prices, so that the cost (utility bill) can be kept the same, while the spikes can be leveraged or smoothen out.

In certain embodiments, the utility company sets different prices for different premises over the same period of time. The burden is on the utility provider to come up with good distribution of prices to premises it servers. For example, some premises get the lowest price later than other homes, using a staggered start. By staggering the start of a low price window, different premises can run the DR process with opportunistic scheduling still allowing premises to schedule as many of their appliances as possible to run at the lowest prices, but since the lowest prices are not happening at the same time for all premises, the total energy consumption can be smoothened out among all the premises.

In certain embodiments, a “self-regulate” DR process is used that can monitor and detect spikes and react accordingly. In various disclosed embodiments, the DR process monitors whether the grid has spike, e.g., via the real time price, or via some specific signaling offered from the grid, etc. If a spike happens, the DR process is able to automatically shift the load to other times.

In certain embodiments, a DR process is designed to preemptively ‘avoid’ causing the spikes. Methods for avoiding causing spikes includes: randomization of the scheduling; searching for the scheduling which would give as flat as possible power usage; and randomly picking one of the scheduling approaches if all achieve the same electric bill. Of course, other processes can be developed that operate with a similar objective that are within the scope of the disclosure, although they are not specifically disclosed.

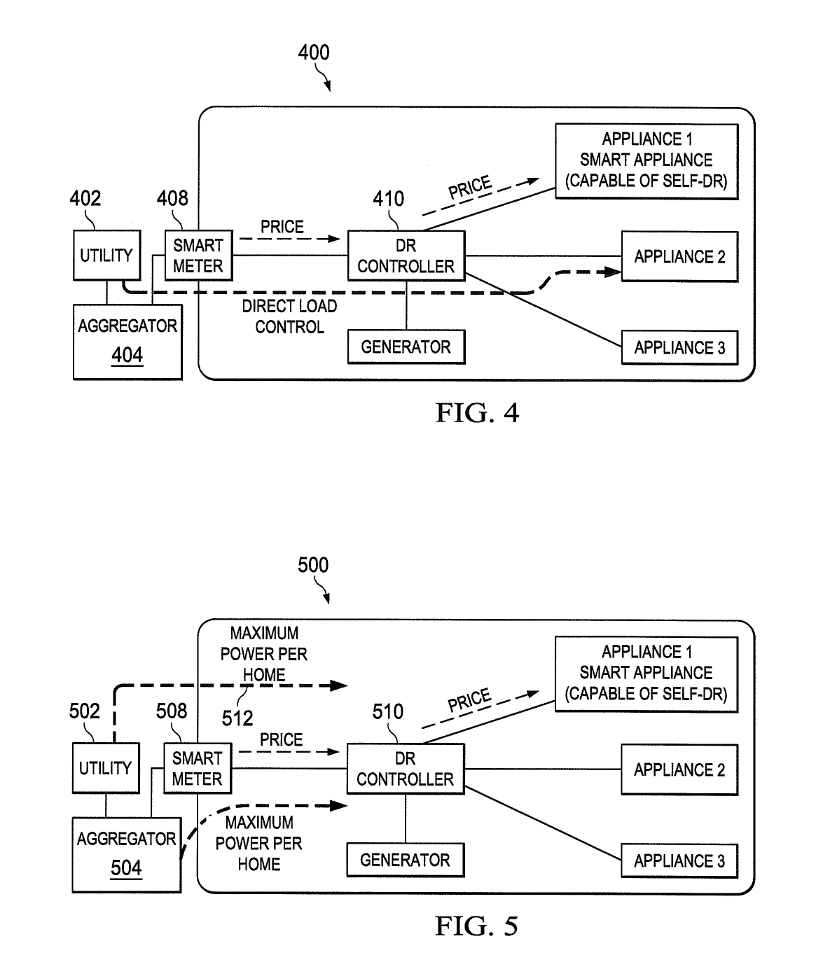

FIG. 4 illustrates a direct scheduling process 400 according to embodiments of the present disclosure. The embodiment of the direct scheduling process 400 shown in FIG. 4 is for illustration only. Other embodiments could be used without departing from the scope of this disclosure.

In certain embodiments, the utility company 402 or aggregator 404 provides the scheduling itself, without providing much, if any, information to the end user. This bypasses the sending of scheduling data directly to the smart meter 408 and the DR controller 410. In these embodiments, the DR process is located inside the utility company, rather than being controlled by a local DR controller 410. The utility 402 uses direct load control for eliminating or reducing the night time rebound peak.

In certain embodiments, a third party provides solutions to the end user, on how to schedule the appliances. The third party may have to average out those potential spikes. The third party can act as an interface between the end-user and the utility. The utility can provide prices and requirements regarding peaks to the third party, then the third party provides scheduling solutions to the end user.

FIG. 5 illustrates a spike control process 500 with max power signaling according to embodiments of the present disclosure. The embodiment of the spike control process 500 shown in FIG. 5 is for illustration only. Other embodiments could be used without departing from the scope of this disclosure.

In certain embodiments, network entities such as a utility company 502 or aggregator 504 provide to the DR controller 510 of each customer, a maximum allowable power consumption signal 512. In addition to sending pricing information via a smart meter 508 or directly to the DR controller, having the maximum allowable power consumption information helps to avoid night time rebound peaks.

In certain embodiments, the maximum allowable power consumption is a “hard” limit, meaning that the customer should not exceed such a limit. In other disclosed embodiments, the network entities such as the utility company 502 or aggregator 504 provides a “soft” maximum allowable power consumption signal 512 to their customers, where the price beyond the “soft” maximum threshold will be higher than the normal price, which is the price when the consumption is no greater than the threshold.

In certain embodiments, the network entities such as the utility company 502 or aggregator 504 provide a “soft” maximum allowable power consumption, where a rebate or incentive is provided to the end user if the consumption is below the “soft” threshold.

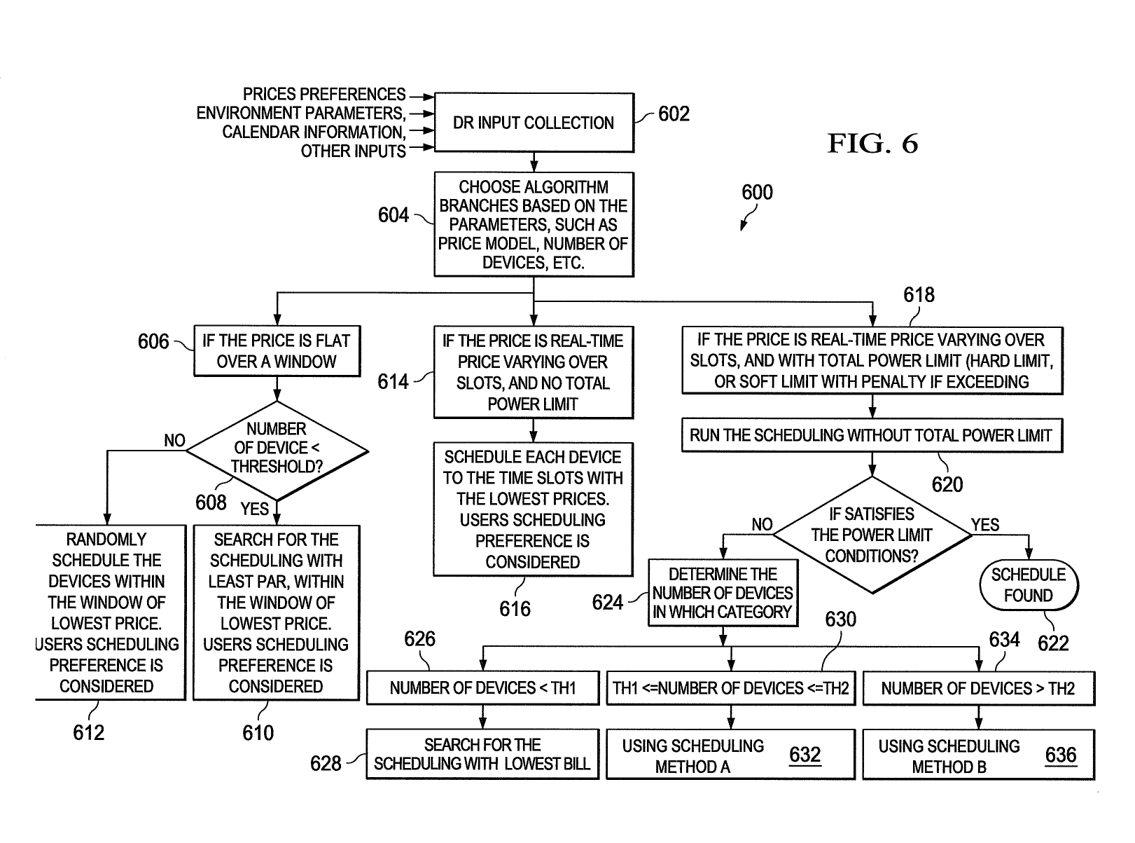

FIG. 6 illustrates a flow diagram of various demand response scheduling processes according to embodiments of the present disclosure. The embodiment of the flow diagram of various demand response scheduling shown in FIG. 6 is for illustration only. Other embodiments could be used without departing from the scope of this disclosure.

In certain embodiments, different methods for scheduling devices are used based on different conditions and parameters. Additionally, different methods for scheduling devices are used for different DR programs that the customer enrolls in.

In step 602, DR input collection occurs. Input for the DR includes electric prices, customer or utility preferences, environment parameters, calendar information, as well as many other similar types of input.

In step 604, the DR controller chooses a process based on the received input parameters, such as a price model, number of devices, or other parameter. For example, in step 606, for the DR program time of use (TOU), flat prices are typically provided over a window, such as one price for peak (usually daytime) and another price for off-peak (usually night). The DR scheduling process is configured to reduce the electricity bill, as well as helping the grid to lower the peak-average-ration (PAR).

In step 608, the number of controlled devices is determined, where if the number of controlled devices is less than a threshold, different scheduling methods can be used. In various disclosed embodiments, the DR scheduling process is, for example, a random scheduling, which schedules devices to start running at random times, while still considering the customer's preference, such as “the job should be done by a certain time,” or “the job should start around some time window,” just to provide two examples.

In certain embodiments, when the number of devices is small, or below a threshold, the DR process performs a search (e.g., exhaustive search), to determine the devices to be run having the lowest PAR, in order to reduce the PAR of the utility within the domain of the customer. (Step 610). The result of such search may result in the same electric bill as doing a random scheduling, but it can provide a lower PAR than the random scheduling in many cases.

In certain embodiments, when the number of devices is not small, or above a threshold, a search can prove to be too computer intensive, and random scheduling is performed. (Step 612). In yet further embodiments, a random scheduling is always performed, regardless of the number of devices.

In certain embodiments, the DR program using real-time-price (RTP) typically has prices varying over every slot, (e.g., every hour, etc.) (Step 614). The DR scheduling process is designed to reduce the bill, as well as helping the grid to lower the PAR. In Step 616, each device is scheduled to the time slots with the lowest prices, with a user's scheduling preferences being taken into consideration.

In certain embodiments, there are instantaneous total power constraints or limits suggested by the power grid, such as by the utility, by the aggregator, and the like, to essentially “coerce” the customer to help lower the PAR of the grid. (Step 618). With total power constraints, if a customer exceeds the “soft” limit, the price for the exceeded portion of the utility would be higher than the regular price, as a penalty. If the customer exceeds a “hard” limit, the utility simply may not provide electricity beyond the total power constraint to the customer. Typically with such total power constraints, a utility needs search to find the best solution, which can be time consuming and computer intensive.

In certain embodiments, using RTP without total power constraints, the process used for the DR scheduling can be the one that schedules each device to the times with the lowest cost, as well as satisfying the customer's preferences such as “the job should be done by a certain time,” or “the job should start around some time window,” and the like.

In certain embodiments, using RTP with total power constraints, the process used for the DR scheduling can be the one that runs the process without the total power constraints (step 620), and if the solution does not violate the total power constraint (step 622), then the solution has been found. Otherwise, the process would continue to the next step, where different methods can be used for different cases with different number of devices (step 624).

For instance, if the number of device is small (step 626), then a search (e.g., exhaustive search) is used for a scheduling with the lowest bill (step 628). If the number of devices is medium (step 630), then another method is used, where such method can be of less computing load while giving good results or not losing too much in optimality (step 632). If the number of devices is large (step 634), then yet another method is used, where the method has less computing load, while not losing too much in optimality (step 636). These are exemplary cases, and can be extended to other similar cases, such as multiple categories of the number of devices.

In certain embodiments, the process will also consider and satisfy the customer's preferences such as the job should be done by a certain time, or should start around some time window, and the like.

In certain embodiments, randomization is used in any DR program, other than the flat price programs (e.g., the DR program with real-time or day-ahead prices). In certain embodiments, if there are multiple scheduling solutions that result in the same bill, the DR process randomly picks one of the solutions. The randomization can further help to lower the PAR of the grid. In certain embodiments, similar handling to the total power constraints on the right branches for non-flat prices such as real-time or day-ahead prices (steps 622-636) is used for other DR programs such as TOU, and the like.

The total power constraint described in FIG. 6 is one example of how the grid can shape the utility usage of customers to help lower the PAR. All the embodiments in this disclosure are not limited to this particular example, rather, they are applicable to other conditions or examples, such as “the total energy consumption within a certain time should be within a limit,” and so forth.

In certain embodiments, using the DR process that is optimal for the problem can be first run without total power constraint. If the solution derived is feasible for the total power constraint, then the process is done. If not, then if a set of conditions A is satisfied, then an exhaustive search A will be carried out, otherwise if a set of conditions B is satisfied, a heuristic process B will be carried out, otherwise another heuristic process C will be carried, out, and so on.

In certain embodiments, the set of devices whose scheduling is determined is denoted as Set 1, the set of devices whose running time is not interruptible is denoted as Set 2, and the set of devices whose running time is interruptible is denoted Set 3. The required total number of time intervals that the device d is running is denoted as R_d, where R_d=int(R_d)+frac(R_d), where int(R_d) is an integer and 0<=frac(R_d)<1 is the fraction part. Device d′s power is denoted as P_d. The energy price at each interval i is denoted as c_i. Assume there are I intervals in a scheduling window.

A method of opportunistic scheduling is as follows:

Schedule Set 1 devices first, then Set 2 and Set 3.

For Set 2 devices, for each device, find the consecutive time intervals with least energy cost, where the consecutive time intervals achieve the total required running time of the device. If there are multiple of consecutive time intervals with the same least energy cost, randomly pick one of them.

Schedule Set 3 devices. Each device can be scheduled to time intervals with least prices, until the required total running time is achieved. Sort the prices of all intervals, c_{i1}<=c_{i2}<= . . . <=c_{iI}. If there are multiple different sort results due to the equal prices, randomly pick one of the sort results. For each device d, and pick up [int(R_d)] intervals: i1, i2, . . . , i[int(R_d)], which are the first [int(R_d)] intervals in the result of the price sort, and utilize the full interval. Pick up interval i[int(R_d)+1], which is the [int(R_d)+1]-th interval in the result of the price sort, and use frac(R_d) portion of the interval. Running time can start at a random time within this interval, as long as the fraction is satisfied.

In certain embodiments, for devices in Set 2 or Set 3, if there is a time requirement such as deadline for a device to finish running, or it has to start by a certain time, then on top of the method above, such time requirement constraint should be considered, and the best solution is that first, the set of required or feasible time intervals is found for each device, then the search as described in above method will be done in the feasible time intervals, instead of all the intervals of the full scheduling window.

In certain embodiments, the set of devices whose scheduling is determined is denoted as Set 1, the set of devices whose running time is not interruptible is denoted as Set 2, and the set of devices whose running time is interruptible is denoted as Set 3. A method can be used as follows:

Schedule Set 1 devices first. Then Set 2. For Set 2 devices: (1) Sort devices by their expected consumed energy R_d*P_d, for all d. (2) Start from the device with maximum R_d*P_d. (3) Assign to the consecutive intervals with the lowest cost based on the energy prices. If there are multiple consecutive time intervals with the same least energy cost, randomly pick one of them. (4) If violating the instantaneous power constraint (e.g., the maximum allowable power or energy in the interval), allocate to the consecutive intervals with the next lowest cost. (5) Repeat 4 until a period of consecutive intervals is found or all the possible consecutive intervals are tried. (6) If such a period of consecutive intervals is not found, then leave the device to next scheduling window (or jointly schedule with the current window and next window). After all devices in Set 2 are done, schedule devices in Set 3. Set 3 scheduling method can be some method included in other embodiments.

In certain embodiments, the set of devices whose scheduling is determined is denoted as Set 1, the set of devices whose running time is not interruptible is denoted as Set 2, and the set of devices whose running time is interruptible is denoted as Set 3.

Schedule Set 1 devices first. Then schedule Set 2. For Set 2 devices: (1) Identify a slot with the lowest price among all the slots not exceeding the total power constraint. (2) For this slot, identify a set of devices which achieves the maximum possible total power within the constraint. Keep these devices in the slot. Shift the scheduling of each device d among these devices to a period of non-interruptible running time of R_d, such that the energy cost during the period of time R_d is the lowest, as long as the running time of device d has covered the slot, i.e., the slot is included in the running time of R_d, and the total power constraint is met in all the slots of the scheduling window. (3) Re-schedule those devices not in the set identified above, with updated power constraint by taking into account the devices kept in step 2, and a removal of the slot identified in step 1. (4) Repeat 1-3 steps until all constraints are satisfied. If exhausting all slots or all devices still does not produce a feasible schedule, then delay the not scheduled device. After all devices in Set 2 are done, schedule devices in Set 3.

In certain embodiments, for Set 3 devices: (1) Identify a slot with the lowest price among all the slots not exceeding the total power constraint. (2) For this slot, identify a set of devices which achieves the maximum possible total power within the constraint. Schedule as much as possible within in R_d for these devices whose R_d>0 in the slot. (3) Update the R_d by reducing the amount already scheduled in Step 2. If R_d=0, remove the device. (4) Remove the slot identified in step 1. (5) Repeat 1-4 steps until exhausting all slots or all devices. (6) Delay the not scheduled devices to the next scheduling interval.

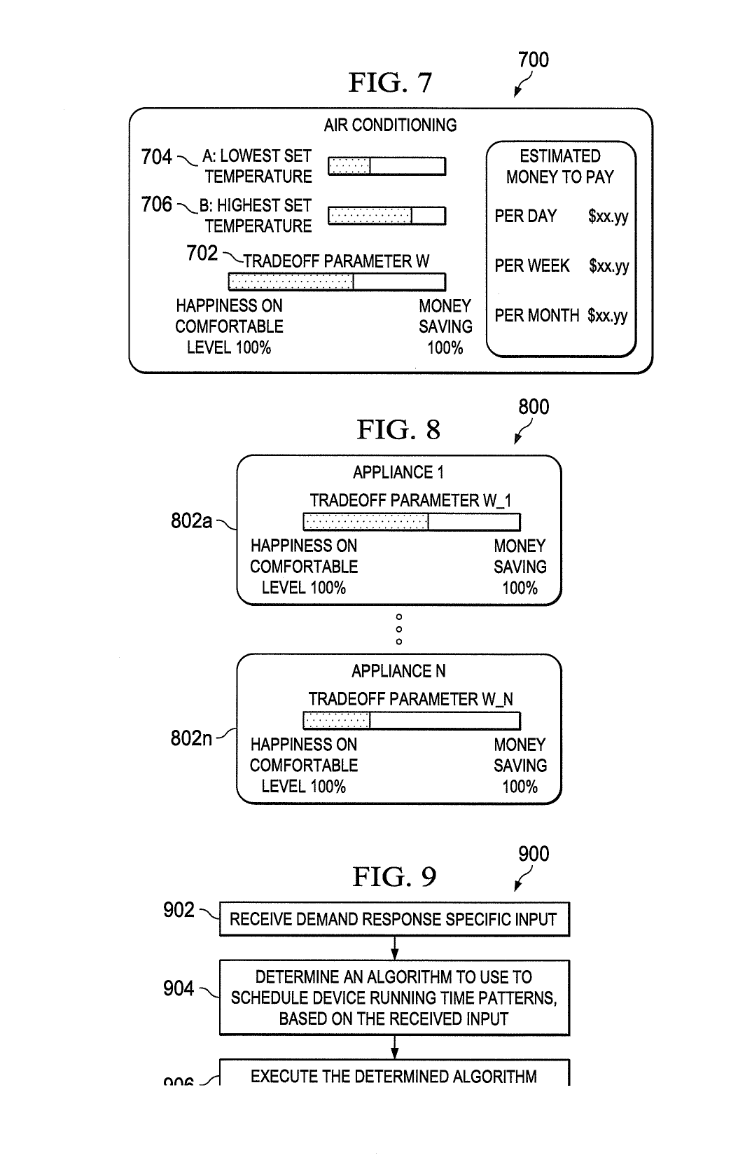

FIG. 7 illustrates a user interface for a device according to embodiments of the present disclosure. The embodiment of the user interface 700 shown in FIG. 7 is for illustration only. Other embodiments could be used without departing from the scope of this disclosure.

As described previously, input parameters can include user preferences, among other things. Often times a user may be flexible on a particular temperature and prefer to save money by emphasizing that over comfort. In various disclosed embodiments, the comfort level can be referred to as a happiness level and may be modeled in relation to other parameters.

For happiness modeling, a certain set of devices can have a range of flexibility to tradeoff “happiness” for savings in electricity consumption. In certain embodiments, a tradeoff parameter is set. The parameter can be a common one for all the devices that have flexibility of trading off the happiness and electricity consumption, or the parameter can be independently set for each of all these devices.

In certain embodiments, once the tradeoff parameter is set, a targeted electricity consumption setting can be calculated, and then the device can be automatically set to the targeted electricity consumption setting, e.g., the temperature that the air conditioning has set as its target.

In certain embodiments, once the tradeoff parameter is set, the DR process calculates the right scheduling for such devices, e.g., to schedule the air conditioning to run how long of the time. Once the tradeoff parameter is set, a targeted electricity consumption setting is calculated, and then the device can be automatically set to the targeted electricity consumption setting, e.g., the temperature that the air conditioning has set as its target.

In certain embodiments, the target temperature is a function of parameters (A,B,W,p) or subset of the parameters, where A,B,W (0<=W<=1) are defined as in the figure and typically the user or the customer can set these values via the user interface. “p” is the electricity price, typically obtained from the grid network via smart meter. Note that a user can set A 704 as the ideal temperature and B 706 as the highest tolerable temperature. E.g., (1−W)*A+W*B, or other functions.

FIG. 7 uses a cooling example for the air conditioning. However, similar methods can be used for a heating example as a straightforward extension. Therefore, the details for a heating example will be omitted.

In certain embodiments, the lowest energy price is denoted as p_1, highest as p_h, then let p_th=(1−W)*p_h+W*p_1. Here, W 702 is interpreted to be a user's desired tradeoff on the highest price and the lowest price, and p_th is interpreted as the highest price that the user is willing to pay for the energy. If the current price p>p_th, then set the target temperature as B 706 (highest tolerable temperature); otherwise, the temperature as (1−W)*A+W*B.

In certain embodiments, p_th (the highest price that a user is willing to pay for energy) can be set via the user interface directly, rather than derived via a formula.

In certain embodiments, an optimization problem can be solved for best E: maximize (1−W) log (E)−W*p*E, where E (the energy consumption) is the variable, and E_A>=E>=E_B, where E_A and E_B are the corresponding energy consumption if the temperature should be A and B, and p is the real-time price of the electricity.

For example, if there is no one in the room, the temperature is set to B, or C (a value typically higher than A & B), and the room can be pre-cooled based on schedules, and so forth, using calendars or other inputs.

In various disclosed embodiments an optimization for best E can be solved: maximize\sum_i (1−W_i) log (E_i)−W_i*p*E_i, where E_i (the energy consumption of appliance i) is the variable, and E_Ai>=E_i>=E_Bi, where E_Ai and E_Bi are the corresponding energy consumption for a high energy consumption point Ai and low energy consumption Bi, and p is the real-time price of the electricity. A total energy consumption constraint would be considered if any.

FIG. 8 illustrates user interfaces including tradeoff parameter settings 800 for multiple devices according to embodiments of the present disclosure. The embodiments of the user interfaces shown in FIG. 8 are for illustration only. Other embodiments could be used without departing from the scope of this disclosure.

Similar to the tradeoff parameter used in FIG. 7, tradeoff parameter settings 802a-802n (collectively 802) are set by a user for multiple devices. As depicted in FIG. 8, the lower the tradeoff parameter 802, the higher the happiness or comfort level is prioritized. The higher the tradeoff parameter 802 the more cost savings is emphasized over happiness or comfort.

In certain embodiments, a tradeoff parameter 802 is used to show the tradeoff in-between the end-consumer's happiness of the video visual quality such as on TV, laptop, wireless phones, and so forth, and the money that the end-consumer has to pay for the energy consumption to get such video quality. The end-consumer can input the lowest tolerable video quality (such as the resolution, sharpness, and the like), and a tradeoff parameter of the happiness of the video quality and the money consumed to pay for the energy consumption. After receiving the end-consumer's preference, the DR controlling system 200 (including DR controller 202, which can interact with the devices that play video) calculates predicted energy consumption or the money that the consumer has to pay, taking into account the price information. The energy consumption can be related to the video quality: if the video quality is high, it may use higher resolution, higher performance of the video coding and decoding, more backlighting energy consumption, and so forth, which all will consume more energy. Likewise, if the video quality is low, it may consume less energy. After the end-consumer receives the feedback of the query of the input parameters, the end-consumer can further adjust the input parameter or preferences to iterate the predicted money consumption as needed. If the end-consumer has agreed to set the parameters or preferences, the DR controller 202 can interact with the devices that will play the video to adjust the quality of video by adjusting the resolution, video coding and decoding, backlighting, and so forth. When the energy price is high, the quality of the video can be set to lower, to save the cost, and when the energy price is high, the quality of the video can be set to higher (e.g., by using more backlighting, higher resolution, coding and decoding with higher performance, and the like).

In certain embodiments, the interface that end-consumer uses to interact with the DR controlling system, to input the preferences, tradeoff parameters, query, and to get feedback of the query, can be any of the displays of devices, such as mobile phone, tablet, notes, laptop, TV, energy management system display, and the like.

In certain embodiments, forecasting of anticipated power use is applied for a given time window. The forecasting is derived from statistical models of power consumption that are appropriate for the demographic and geo-location of a DR target.

FIG. 9 illustrates a process 900 for demand response device timing according to embodiments of the present disclosure.

In step 902, Demand Response (DR) specific input is received. DR specific input includes condition data, local environment metadata, status data, behavioral feedback, energy pricing structures, contextual data.

In step 904, a process to schedule device running time patterns is determined based on the received input. Where the received input indicates that the energy plan includes a flat energy price, a process is selected where devices are scheduled randomly, within a preferred deadline that a user may have indicated. Where the received input indicates that there is a non-flat price, a process is selected where scheduled devices are scheduled as much as possible towards time slots having the lowest price. When there is a constraint regarding a maximum allowable total power, a process can be selected based upon the number of devices, as described previously.

In step 906, the determined process is executed.

Although the figures described above have illustrated various embodiments, any number of modifications could be made to these figures. For example, any suitable type of DR architecture system or could be used. Further, while FIGS. 6 and 9 illustrate various series of steps, various steps in FIGS. 6 and 9 could overlap, occur in parallel, occur multiple times, or occur in a different order. In addition, each component in a device or system could be implemented using any suitable structure for performing the described function(s).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A demand response (DR) architecture for use in an electrical power network comprising:
a plurality of smart meters, sensors, and appliances;
a DR controller; and
a processor associated with the DR controller, wherein the processor is configured to:
receive DR specific input;
determine a process to use to schedule device running time patterns based on the received input; and
execute the determined process.

2. The DR architecture as set forth in claim 1, wherein the processor, in receiving DR specific input, is configured to receive one or more of condition data, local environment metadata, status data, behavioral feedback, energy pricing structures, and contextual data.

3. The DR architecture as set forth in claim 2, wherein when said energy pricing structure comprises a flat energy price, schedulable devices are randomly scheduled using the determined process and within any preferred deadline constraints.

4. The DR architecture as set forth in claim 2, wherein when said energy pricing structure comprises a non-flat energy price, the determined process schedules devices to operate as much as possible towards time slots with a lowest price.

5. The DR architecture as set forth in claim 2, wherein said energy pricing structure further comprises a constraint on maximum allowable total power, the processor is further configured to perform a search for scheduling with a minimum energy cost.

6. The DR architecture as set forth in claim 1, wherein the processor, in receiving DR specific input, is configured to receive tradeoff parameters indicative of a user preference between performance or comfort and energy savings.

7. The DR architecture as set forth in claim 2, wherein said local environment metadata data comprises one or more of the following: humidity, temperature, occupancy, window status, door status, blind/shutter status, and sensor data.

8. The DR architecture as set forth in claim 2, wherein said contextual data comprises cloud based contextual data including one or more of the following: energy trading data, historical use data, disambiguated personal data, and weather information.

9. The DR architecture as set forth in claim 2, wherein said behavioral feedback comprises one or more of the following: e-mails, short messages, scheduler, and calendars.

10. The DR architecture as set forth in claim 2, wherein the processor is further configured to output a scheduling vector and device controller to schedule devices to run, using data analyzed by an analytics engine and the determined process.

11. For use in an electrical power network capable of automatically adjusting electrical demand, a method of selecting an process to use for scheduling devices, the method comprising:
receiving by a demand response controller, demand response specific input;
determining an process to use to schedule device running time patterns based on the received input; and
executing the determined process.

12. The method as set forth in claim 11, further comprising receiving one or more of condition data, local environment metadata, status data, behavioral feedback, energy pricing structures, and contextual data.

13. The method as set forth in claim 12, wherein said energy pricing structure comprises a flat energy price, determining the process schedule for schedulable devices randomly and within any preferred deadline constraints.

14. The method as set forth in claim 12, wherein said energy pricing structure comprises a non-flat energy price, determining the process schedule for schedulable devices to operate as much as possible towards time slots with a lowest price.

15. The method as set forth in claim 12, further comprising wherein said energy pricing structure further comprises a constraint on maximum allowable total power, performing a search for scheduling with a minimum energy cost.

16. The method as set forth in claim 11, further comprising receiving tradeoff parameters indicative of a user preference between performance or comfort and energy savings.

17. The method as set forth in claim 12, wherein said local environment metadata data comprises one or more of the following:
humidity, temperature, occupancy, window status, door status, blind/shutter status, and sensor data.

18. The method as set forth in claim 12, wherein said contextual data comprises cloud based contextual data including one or more of the following: energy trading data, historical use data, disambiguated personal data, and weather information.

19. The method as set forth in claim 12, wherein said behavioral feedback comprises one or more of the following: e-mails, short messages, scheduler, and calendars.

20. The method as set forth in claim 12, further comprising scheduling devices to run, using data analyzed by an analytics engine and the determined process, using a scheduling vector and device controller.
